(19) United States
(12) Patent Application Publication
(10) Pub. No.: US 2007/0201676 A1
(43) Pub. Date: Aug. 30, 2007

(54) Supervising monitoring of agents

(75) Inventors: W. James Gillis JR., Andover, MA (US); Aaron B. Flett, Merrimack, NH (US); Edwin Robbins JR., Sandown, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: Aspect Software Company

(21) Appl. No.: 11/362,347

(22) Filed: Feb. 24, 2006

(51) Int. Cl. H04M 3/00; H04M 5/00

(52) U.S. Cl. 379/265.01

(57) ABSTRACT

A system, method, and device for monitoring communications or agents in a contact center are disclosed. The exemplary system may have a monitoring station for transmitting a request to monitor an agent. A server of the exemplary system may have a servlet container and filter portion for receiving and routing requests and responses of agents and customers. The filter may produce a copy of at least one response and request received by the agent. The server may communicate the copy to the monitoring station when the request to monitor from the monitoring station is received by the server.

### TECHNICAL FIELD

The present invention relates to a contact center and more particularly, to a device, method, and system for monitoring communications or agents in a contact center.

### BACKGROUND INFORMATION

Contact centers place and receive telephone calls, emails, textual chats, and other methods of communication (hereinafter collectively referred to as “communications”) to customers. Agents at the contact center handle the communications with the customer and guide the customer in obtaining information or providing the requested information. Customers may include current customers, previous customers, and individuals with information or with a desire to obtain additional information.

A growing number of businesses have begun using contact centers to handle interactions between customers. Companies typically use contact center services, for example, to manage outbound and inbound communications campaigns to potential customers for telemarketing or to existing customers for collections information or customer follow-up. At any particular time a contact center may be handling multiple campaigns for multiple businesses.

Contact centers may have a first group of agents assigned to one campaign and a second group of agents assigned to a second campaign. Agents assigned to a campaign may need access to specific knowledge to assist the agent in responding to customers' questions and requests. The agent may be provided with a Web browser to allow the agent to access the relevant information on the Web and/or private databases. The relevant information may be information associated with the customer, product, or service. The beneficial information may also be suggested scripts to assist the agent in responding to the customer during a telephone conversation.

Supervisors oversee the agents and aid agents in handling customer interactions. Supervisors are often responsible for multiple agents. In order to better assist agents, supervisors may need to have immediate access to the resources or information currently in use by the agent. Supervisors may also need to coach the agent on efficient use and access of relevant information. The information and resources used by the agent may be a variety of Web-based communications using Hyper Text Transfer Protocol (HTTP). Accordingly, a need exists for a device, method, and system that provides supervisors with access to information the agent is actively accessing in a Web-based communication. In addition the device, method, and system needs to be able to determine which Web-based communications are associated with a specific agent and customer communication session.

### SUMMARY

The present invention is a novel device, system, and method for monitoring communications or agents in a contact center. An exemplary embodiment, according to the present invention, initiates a request from a workstation. The request is communicated from the workstation to a server. A response to the request may be generated automatically by the server. One or more response objects may be automatically produced with a servlet container of the server in response to the request. The response object may be associated with request objects of the request. The request may be automatically parsed for one or more request objects to determine a routing destination and modify the response objects based on the routing destination with a filter portion of the servlet container. Rules of the filter portion may determine the routing destination and may modify the response objects. The modified response object may be used to route the response to the previously determined destination.

In an alternative embodiment, the exemplary method for routing a request in a contact center may also communicate rule modifications from a filter maintenance module to the filter portion. The rules of the filter portion may be modified by the rules sent from the filter maintenance module. The modified rules then may be used to route the requests.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings herein:

FIG. 1 is a block diagram of a system for monitoring communications or agents in a contact center according to the present invention.

FIG. 2 is a flow chart illustrating a first exemplary embodiment of a method for monitoring communications or agents in a contact center according to the present invention.

FIG. 3 is a flow chart illustrating an example of the method for monitoring communications or agents in a contact center according to the present invention.

FIG. 4 is a flow chart illustrating a second exemplary embodiment of a method for monitoring communications or agents in a contact center according to the present invention.

### DETAILED DESCRIPTION

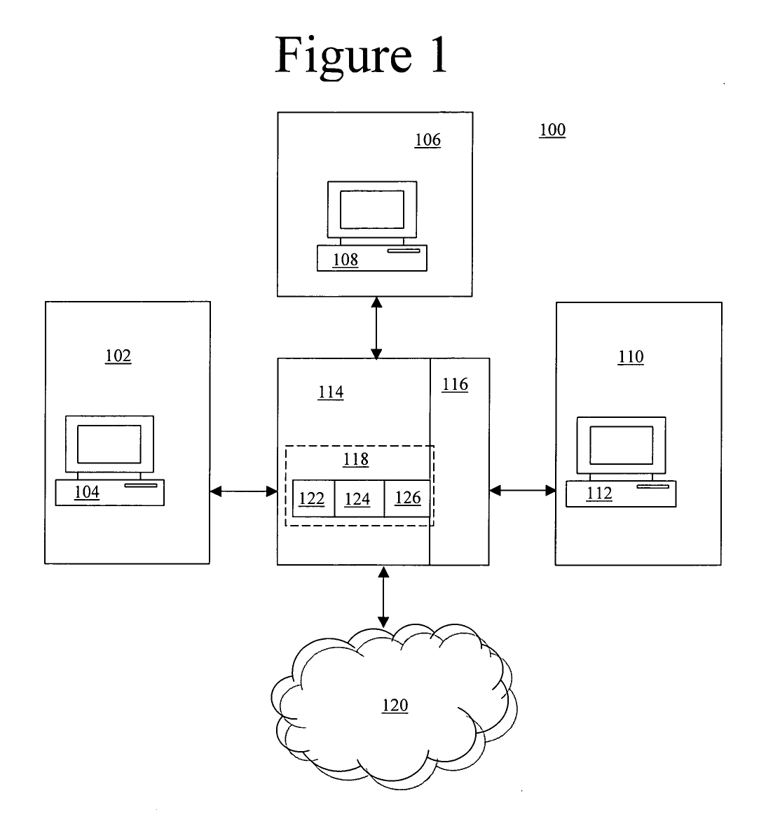

FIG. 1 is an exemplary system diagram of a system 100 used to monitor communications or agents in a contact center. An agent 102 may be an individual working at an agent workstation 104 within the contact center environment that interfaces with the customer 106. The agent 102 may also be a completely automated system that provides or receives information from the customer 106. The customer 106 is represented generally as working at a customer workstation 108. A supervisor 110 at a supervisor's workstation 112 monitors interactions between the agent 102 and the customer 106.

The agent workstation 104 may be a personal computer or other device for utilizing a Web browser to interface with internal databases and external databases as well as customers 106. The customer workstation 108 and the supervisor workstation 112 may also be personal computers or other devices for utilizing a Web browser to interface with the agent 102 via the server 114. The agent workstation 104, customer workstation 108, and supervisor workstation 112 may also include telephone sets or other communication devices for communicating with each other (not shown).

the agent 102 or the customer 106 initiates a communication session. The communication may be via a telephone communication session or a communication session via a Web application. During the course of a telephone communication session the agent 102 may use a Web application to gather information relevant to the telephone communication. This information may be information associated with the customer 106, product, or service relevant to the communication. The information may also be sample scripts to provide the agent 102 with answers or advice to provide to the customer 106. To initiate the sample script request, the agent 102 originates a request to the server 110.

The server 110 responds and routes the request. The server 110 of the system 100 may include a servlet container 116. The servlet container 116 may have a minimum specification of a 2.3 Servlet Specification. The Tomcat 4.x server is an example of a server 110 having an acceptable specification servlet container 112. The Tomcat 4.x server is available through Apache Software Foundation. The servlet container 116 provides a runtime environment in which Web applications run, as well as the tools necessary to deploy the Web applications.

The server 114 also has at least one filter interface or portion 118. For illustration purposes the filter portion 118 of the system 100, as shown in FIG. 1, is shown as a separate piece of equipment. However, the filter portion 118 may not be a separate piece of equipment. The filter portion 118 may be a part of the servlet container 116 as provided in the exemplary 2.3 Servlet specification. The filter portion 118 may be a Java class that implements the filter interface and provides for pre- and post-processing of requests and responses.

The server 114 may route the request to the appropriate destination to service the request. The appropriate destination may be a local database or a database connected through an outside network 120. A response is generated and sent to the agent 102 in reaction to the agent's request. The response provides the agent 102 with the requested information or directs the Web application of the agent 102 to the requested information. The agent 102 may then view the relevant information on a display of the agent workstation 104. The agent 102 may then decide pertinent information and relay the information to the customer 106 during the agent's telephone dialogue with the customer 106.

The communication session between the agent 102 and customer 106 may also be via a Web application. The agent 102 or the customer 106 may at any time originate a request to the server 114 to initiate a HyperText Markup Language (HTML) communication session. In use, the agent 102 may make the request to the server 114 via the agent workstation 104. The server 110 communicates the request to the servlet container 112. In tandem with receiving the request, the servlet container 116 of the server 114 may create request objects, a response and response objects. The request objects and response objects represent the HTML transaction between the customer 106 and the agent 102. The request object contains all pertinent information about the request and the response object contains information about the response. For example, but not limited to, the request objects and response objects may include the IP address, destination address, request path, request context, etc. of the customer. The servlet container 116 passes the request object to the filter portion 118 and then to the agent's workstation 106 as part of the response. It is important to note that neither the request objects nor response objects are sent to the customer. Below is a table of an example request and response for a potential catalog customer.

| | |
|---|---|
| Request | Response |

| | | | |
|---|---|---|---|
| Name | Aaron Buyer | Name | Aaron Buyer |
| Monitoring | Undefined | Monitoring | Susan Supervisor |
| Reference ID | 1051005 | Reference ID | 1051005 |
| Agent | Undefined | Agent | Joe Agent |
| Initiated | customer | Initiated | customer |

The request objects associated with the above request include “Aaron Buyer”, “Undefined”, “1051005”, “Undefined” and “customer”. The request objects are the values that are added to the HTTP request. Similarly, the response objects associated with the above response include “Aaron Buyer”, “Susan Supervisor”, “1051005”, “Joe Agent” and “customer”.

The response objects are the values that are added to the HTTP response. The request objects and response objects are not limited to the above example. The request objects and response objects may be a variety of values. The transactions come in from the agent via an agent application, for example, a Web browser that is communicating using the HTTP protocol. The request is placed into the server 114 or servlet container 116, which in turn has a filter portion 118 set up to preprocess the request. The filter portion 118 is set to identify the predefined request objects. The filter portion 118 examines the request to determine if a request object is associated with a supervisor.

If a request object is associated with a designated supervisor, the response to the request may be produced and sent to the designated supervisor based on the request object via a servlet running in the servlet container 116. The servlet can deliver and distribute the response in a variety of manners. For example, an application on the supervisor's workstation 112 may poll the servlet 116. In another example the servlet 116 may place the response in a queue, which is then interrogated by an application of the supervisor's workstation designated by the request.

In addition to identifying requests and responses to be monitored, the servlet container 116 may indicate and mark requests and responses to monitor. The servlet container 116 creates unique tokens for both the requests and the responses. The unique token is a string identifier that is used to keep HTML transactions separate from each other. The unique token may also be the presence of a string. In the above example request and response, the unique token may be any of the request objects or response objects.

The filter portion 18 may include a plurality of filters that are operatively connected in series or in a chain. In FIG. 1 the exemplary embodiment shown has three filters 116, 118, 122; however the number of filters is not limited to three. The number of filters may depend upon the desired function as explained below. In the exemplary embodiment, the system 100 has a first filter 116, a second filter 118, and a third filter 120.

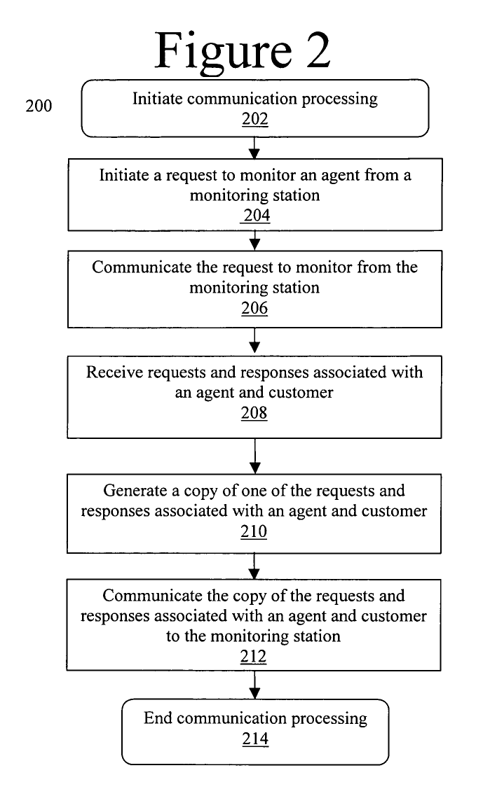

A first exemplary method of the invention, shown in FIG. 2, provides a method of monitoring communications or agents in a contact center. The communication between the agent and customer is initiated (block 202). The supervisor may initiate a request to monitor an agent from a monitoring station of the supervisor (block 204). The request may be generated by the supervisor or an application that triggers the request based on the occurrence of a predefined event. The request to monitor is transmitted from the monitoring station to the server of the contact center (block 206). The servlet container modifies rules of the filter portion based on the request to monitor. The filters parse requests and responses for one or more objects to determine if the request or responses are associated with the request to monitor (block 208). When the filter observes an object associated with the request to monitor, the filter may apply a rule that generates a copy of the request or response (block 210). The copy of the request or response is transmitted to the monitoring station (block 212). The original request or response may also be transmitted to an agent or customer as originally intended. The processing of the communication is completed (block 214).

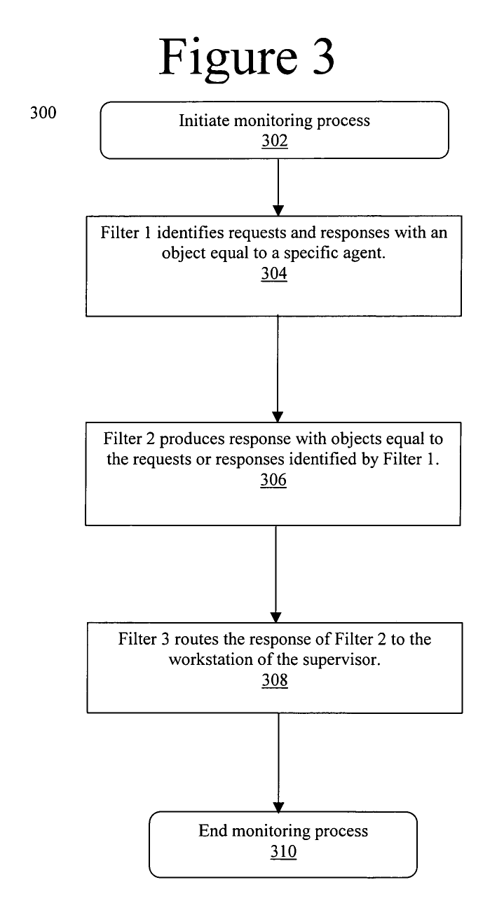

Referring to FIG. 3, a flow chart illustrates an example of the method for monitoring communications or agents in a contact center. The method 300 illustrates the use of rules within filters to monitor an agent within a contact center that is administrating a campaign associated with personal loans. A customer places a telephone call for additional information regarding a loan to the contact center. The contact center routes the call to an agent. The agent submits a request via a Web browser to access script pages while continuing to carry on a conversation with the customer. The script pages are not provided to the customer but allow the agent to review additional information about the customer and loans available to the customer. A supervisor may decide to monitor the agent's activities. As previously discussed, this may be triggered directly by the supervisor or an application may notify the supervisor and automatically trigger monitoring, for example, when a specific script page is accessed by the agent. A request is produced with request objects based on the desired monitoring. The request object of the request to monitor may be, for example, the agent's name, the customer's name or the reference ID. The server receives the request and modifies the filter rules based on the request objects of the monitoring request. For example, rules for filter 1 may be modified to parse requests and responses for a response object of the agent's name. Filter 1 identifies responses and requests containing an object equal to the agent's name (block 304). The response or request is routed to filter 2. Filter 2 produces a copy of the response or request with objects equal to the original response or request (block 306). Filter 3 routes the original request or response to the workstation of the agent and the copy of the response or request to the workstation of the supervisor (block 308). The agent receives the response with the requested script. The supervisor is allowed to see the requests for scripts made by the agent and review the scripts at the same time the agent is receiving the script. The server may continue the monitoring process until the supervisor notifies the server via a request to suspend the monitoring process or no new requests or responses have been detected for a given period of time. The communication processing is completed (block 310). The method and system allow the server to respond to agents' requests in real time and provide supervisors with the ability to monitor agents' HTTP transactions in real time.

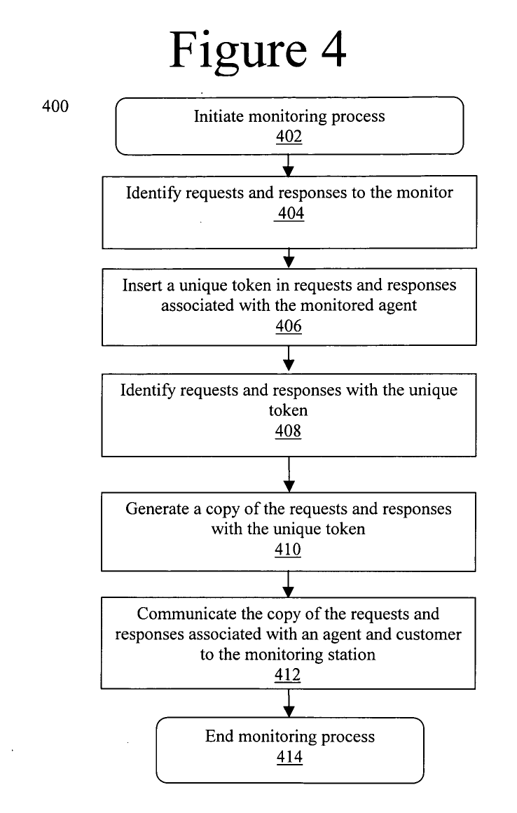

The second exemplary embodiment 400, shown in the flow chart illustrated in FIG. 4, provides a method for modifying the rules of the filters. The supervisor may initiate the rule modification by a request or other communication device to the server (block 402). The filter rules may need to be updated when a supervisor or other personnel decide to monitor an agent or communication session of the contact center or to end the monitoring of the communication. For example, when the supervisor decides or is notified to monitor a communication session of an agent, the supervisor workstation may send a request to the server. The request may contain the details regarding the monitoring session. For example, but not limited to, the request may include the supervisor, agent, customer, transaction identification, and specified time period. Selected information may be used from the request to provide the monitoring criteria. The selected information is entered into the rule modifications in the filter maintenance module (block 404). The filter maintenance module may poll the filters to determine whether the rules entered into the filter maintenance module are different from and more recent than the rules currently in the filter (block 406). If the rules are different and more recent, the rules are communicated from the filter maintenance module to the filters (block 408). The filter maintenance module may also be programmed to automatically change or substitute rules in the filter based on predefined scheduled changes. For example, if a time period is provided, the filter maintenance module may use the specified time period to initiate updating of the filter rules. After the rules are modified the communications may be copied and routed based on the updated rules of the filters (block 410). The rule modification is complete and waits for the next scheduled or requested updates (block 412).

The exemplary embodiments described herein may be associated with the processor and memory associated with the server of the contact center or a host computer for each campaign. In addition, the aspects described in the exemplary embodiments may also be implemented in a variety of digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, a communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a system, device, or method which must satisfy one or more of any stated or implied object or feature of the invention and is not limited to the exemplary embodiments described herein. Modifications and substitutions by one of ordinary skill in the art are considered to be within the scope of the present invention.

The invention claimed is:

1. A system for monitoring a communication in a contact center, the system comprising:
a monitoring station for transmitting a request to monitor an agent;
a server having a servlet container and filter portion for receiving and routing requests and responses of agents and customers wherein the filter produces a copy of at least one response and request received by the agent and communicates said copy to the monitoring station when the request to monitor from the monitoring station is received by the server.

2. The system of claim 1, wherein the agent and customer requests and the responses are a hypertext transfer protocol.

3. The system of claim 1, wherein the filter portion inserts a unique token in requests and responses associated with the monitored agent to identify requests and responses to copy and communicate to the monitoring station.

4. The system of claim 1, wherein the request to monitor is prompted by an individual using the monitoring station.

5. The system of claim 1, wherein the request to monitor, copying and communicating of agent responses and requests are carried out in real time.

6. The system of claim 1, wherein the agent requests and responses are script pages for the agent during an active dialogue with the customer.

7. The system of claim 1, wherein the agent is an automated response system.

8. A method for monitoring a communication in a contact center, the method comprising the acts of:
initiating a request to monitor an agent from a monitoring station;
communicating the request to monitor from the monitoring station to a server;
receiving requests and responses associated with an agent and customer by a filter portion of the server;
responding by the filter portion to said request to monitor by automatically generating a copy of one or more requests and responses associated with an agent and customer; and
responding by the filter portion to said request to monitor by automatically communicating the copy of one or more requests and responses associated with an agent and customer to the monitoring station.

9. The method of claim 8, wherein the agent and customer requests and the responses are a hypertext transfer protocol.

10. The method of claim 8, further comprising the act of:
inserting by the filter portion a unique token in requests and responses associated with the monitored agent to identify requests and responses to copy and communicate to the monitoring station.

11. The method of claim 8, wherein the act of initiating the request to monitor is prompted by an individual using the monitoring station.

12. The method of claim 8, wherein the acts of the method are carried out in real time.

13. The method of claim 8, wherein the agent requests and responses are script pages for the agent during an active dialogue with the customer.

14. The method of claim 8, wherein the agent is an automated response system.

15. A computer program product, tangibly embodied in an information carrier, for monitoring an agent in a contact center, the computer program product being operable to cause a machine to:
initiate a request to monitor an agent from a monitoring station;
communicate the request to monitor from the monitoring station to a server;
receive requests and responses associated with an agent and customer by a filter portion of the server;
respond by the filter portion to said request to monitor by automatically generating a copy of one or more requests and responses associated with an agent and customer; and respond by the filter portion to said request to monitor by automatically communicating the copy of one or more requests and responses associated with an agent and customer to the monitoring station.

16. The computer program product of claim 15, wherein the agent and customer requests and the responses are a hypertext transfer protocol.

17. The computer program product of claim 15, further comprising the act of:
inserting by the filter portion a unique token in requests and responses associated with the monitored agent to identify requests and responses to copy and communicate to the monitoring station.

18. The computer program product of claim 15, wherein the act of initiating the request to monitor is prompted by an individual using the monitoring station.

19. The computer program product of claim 15, wherein the acts of the method are carried out in real time.

20. The computer program product of claim 15, wherein the agent requests and responses are script pages for the agent during an active dialogue with the customer.
